(19) United States
(12) Patent Application Publication
(10) Pub. No.: US 2006/0269129 A1
(43) Pub. Date: Nov. 30, 2006

(54) Video signal processing device and video signal processing method

(75) Inventor: Satoru Tanigawa, Hyogo (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/439,225

(22) Filed: May 24, 2006

(30) Foreign Application Priority Data
May 27, 2005 (JP) 2005-155562

(51) Int. Cl. G06K 9/00

(52) U.S. Cl. 382/169

(57) ABSTRACT

A gray scale conversion table memory stores data obtained by normalizing a luminance cumulative histogram, and when receiving an input luminance value as an address, outputs gray scale conversion luminance data obtained by gray scale conversion (flattening of a luminance distribution, etc.). A frequency component correction circuit increases a higher frequency component of a luminance portion having a small slope in the normalized cumulative histogram. Thereby, a reduction in sharpness or the like is suppressed in a luminance portion to which a less number of gray scales are assigned.

### BACKGROUND OF THE INVENTION

1. Field of the Invention

The present invention relates to a video signal processing device and a video signal processing method which are used in an image capturing apparatus (e.g., a camcorder, etc.), an image display apparatus (e.g., a liquid crystal display, etc.), and the like to perform gray scale correction or the like with respect to video signal data.

2. Description of the Related Art

In recent years, it has become increasingly important to provide sharper video with an improvement in image quality in image display apparatuses, such as a liquid crystal display, a plasma display, and the like, and apparatuses, such as a television set, a DVD (Digital Versatile Disc) apparatus, a VTR (Video Tape Recorder), a camcorder, a digital camera, and the like. To achieve this, for example, gray scale correction is performed to expand the gray scale of an input video signal so as to effectively use a dynamic range.

The gray scale correction is performed using a gray scale correction device including, for example, a histogram calculation circuit and a lookup table (see, for example, JP No. 3-126377 A). Specifically, for example, as illustrated in FIG. 7 in the document, initially, a histogram cumulative adder 9 calculates cumulative histogram data (cumulative frequency) based on a luminance distribution of an input luminance signal held by a histogram memory 8, and causes a cumulative histogram memory 10 to hold the data. A lookup table calculation circuit 11 causes a lookup table memory 12 to hold lookup table data which is obtained by normalizing each data value so that a maximum cumulative frequency becomes a maximum value of an output luminance signal. The lookup table memory 12 outputs a signal obtained by converting the gray scale of an input luminance signal based on the lookup table data.

Further, as illustrated in FIG. 1 and the like of the document, a technique of correcting the above-described histogram data and controlling the degree of gray scale conversion, depending on the luminance, to improve the image quality, is also proposed.

In the above-described gray scale conversion using a lookup table obtained by normalizing histogram data, a larger number of gray scales are assigned to a luminance portion having a high frequency of the distribution, while a smaller number of gray scales are assigned to a luminance portion having a low frequency of the distribution. Thereby, the whole video is likely to have a high contrast. However, a region which has a luminance having a small frequency in the distribution disadvantageously has a low contrast and a low sharpness. Such a problem similarly arises when histogram data is corrected so that the degree of gray scale conversion is controlled.

### SUMMARY OF THE INVENTION

In view of the above-described problem, an object of the present invention is to improve image quality by suppressing a reduction in sharpness of a luminance portion which is assigned with a less number of gray scales by luminance conversion (e.g., a luminance portion which has a low frequency in a luminance distribution).

To achieve the object, a video signal processing device according to the present invention comprises a gray scale conversion section of receiving first luminance signal data, and based on the first luminance signal data, subjecting the luminance signal data to gray scale conversion into second luminance signal data, and a correction section of subjecting the second luminance signal data to at least one of frequency component correction which increases or decreases a predetermined frequency component, and contour emphasis correction which emphasizes a contour portion, based on at least one of the first luminance signal data and the second luminance signal data.

In addition, for example, the correction section is configured so that a ratio of a difference between two post-conversion values obtained when two pre-conversion values having a predetermined difference, a range between the two pre-conversion values including a certain value of the first luminance signal data, are subjected to gray scale conversion in the gray scale conversion section, to a difference between the two pre-conversion values, is smaller than a ratio corresponding to another value of the first luminance signal data, the frequency component correction which further increases the predetermined frequency component or the contour emphasis correction which further emphasizes a contour portion, is performed.

Thereby, for example, in a correction section, a process of increasing or decreasing a predetermined frequency component or a process of emphasizing a contour is performed even for a luminance portion to which a less number of gray scales are assigned by a gray scale conversion section, so that a reduction in sharpness is suppressed and the influence of noise is reduced, resulting in an improvement in image quality.

### BRIEF DESCRIPTION OF THE DRAWINGS

FIG. 1 is a block diagram illustrating a configuration of a video signal processing device according to Embodiment 1.

FIG. 2 is an explanatory diagram indicating gray scale conversion characteristics of a gray scale conversion table memory 106 of the video signal processing device of Embodiment 1.

FIG. 3 is an explanatory diagram indicating a frequency component correction gain of a frequency component correction table memory 108 of the video signal processing device of Embodiment 1.

FIG. 4 is a block diagram illustrating a detailed configuration of a frequency component correction circuit 109 of the video signal processing device of Embodiment 1.

FIG. 5 is an explanatory diagram illustrating an exemplary signal of each section of the video signal processing device of Embodiment 1.

FIG. 6 is a block diagram illustrating a configuration of a video signal processing device according to Embodiment 2.

FIG. 7 an explanatory diagram illustrating an exemplary signal of each section of the video signal processing device of Embodiment 2.

FIG. 8 is a block diagram illustrating a configuration of a video signal processing device according to Embodiment 3.

FIG. 9 is an explanatory diagram indicating gray scale conversion characteristics of a gray scale conversion circuit 300 of the video signal processing device of Embodiment 3.

FIG. 10 is a block diagram illustrating a configuration of another video signal processing device of Embodiment 3.

### DETAILED DESCRIPTION OF THE PREFFERED EMBODYMENTS

Hereinafter, embodiments of the present invention will be described in detail with reference to the accompanying drawings. Note that, in each embodiment, parts having functions similar to those of other embodiments are designated with the same reference characters and will not be repeatedly described.

### Embodiment 1

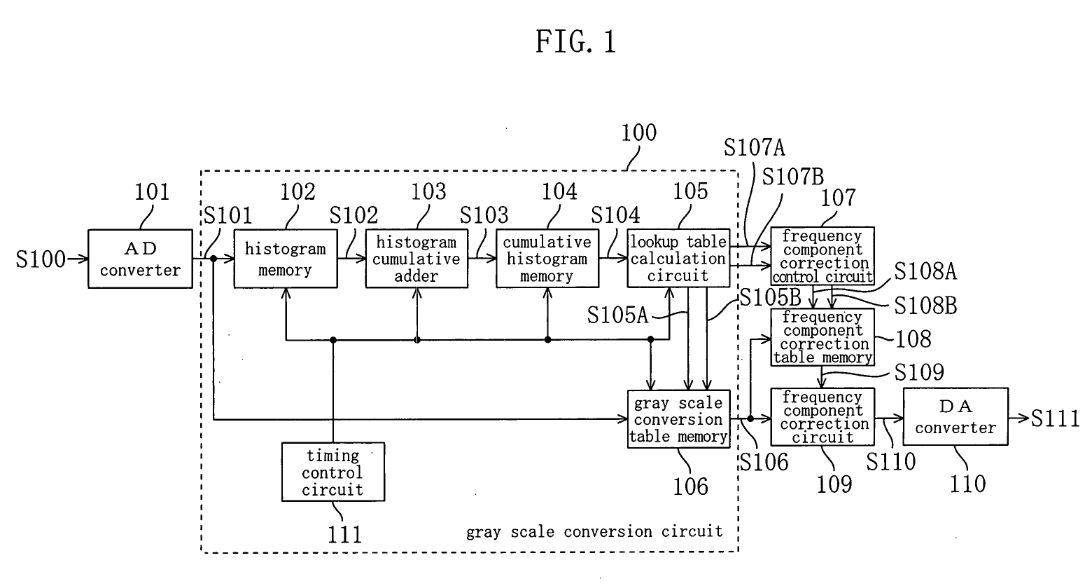

FIG. 1 is a block diagram illustrating a configuration of a video signal processing device according to Embodiment 1 of the present invention. The video signal processing device 1 comprises a gray scale conversion circuit 100 which performs gray scale conversion called equalization of a luminance distribution, and a frequency component correction circuit 109 which can increase a predetermined frequency component (e.g., a higher frequency component). Hereinafter, this will be described in detail.

An AD converter 101 converts an input luminance signal S100 into an input luminance value S101, which is a digital value.

A histogram memory 102 stores a luminance distribution of the input luminance value S101. Specifically, for example, a frequency of each input luminance value S101 (the number of pixels having each input luminance value S101) is stored in a memory area having the luminance value as a memory address. The stored frequencies are output as histogram data S102 in order of luminance.

A histogram cumulative adder 103 calculates a cumulative value of the histogram data S102, and outputs the cumulative value as cumulative histogram data S103.

The cumulative histogram memory 104 stores the cumulative histogram data S103 for each luminance. Specifically, for example, the cumulative histogram data S103 (cumulative frequency) is stored in a memory area having a luminance value as a memory address, and is output as cumulative histogram memory data S104.

A lookup table calculation circuit 105 normalizes the cumulative histogram memory data S104 so that a maximum cumulative frequency of the cumulative histogram memory data S104 is equal to a maximum value of an output luminance signal, and outputs normalized cumulative histogram data S105B (lookup table data) which is associated with a luminance value S105A.

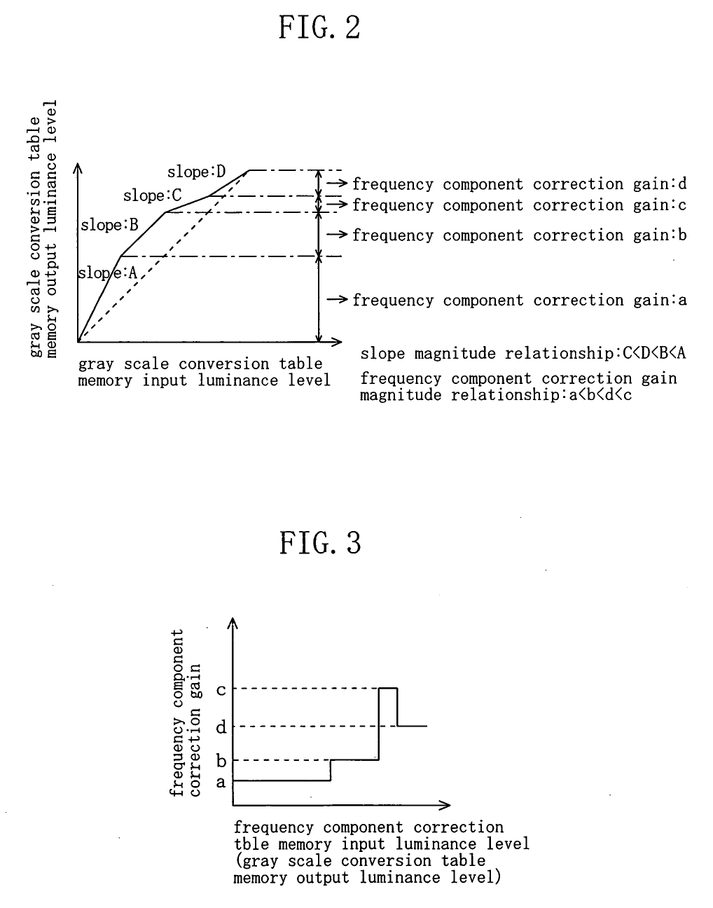

A gray scale conversion table memory 106 (lookup table memory) stores the normalized cumulative histogram data S105B, and based on this, converts a gray scale of the input luminance value S101 to output gray scale conversion luminance data S106. Specifically, for example, as illustrated in FIG. 2, the normalized cumulative histogram data S105B (gray scale conversion table memory output luminance level) is stored in a memory area which has, as an address, the luminance value S105A (gray scale conversion table memory input luminance level) output from the lookup table calculation circuit 105. Therefore, when the input luminance value S101 is input as an address to the gray scale conversion table memory 106, the gray scale conversion luminance data S106 is output. Here, in the example of FIG. 2, the input and output luminance levels have a linear relationship having a four-stage slope. The present invention is not limited to this. The number of slope stages may be reduced so that the circuit scale or processing load can be reduced, or alternatively, the number of slope stages may be increased so as to increase conversion precision.

A frequency component correction control circuit 107 calculates frequency component correction gains (a to d) which indicate a degree of an increase in a predetermined frequency component, depending on the slopes (A to D in FIG. 2) of the normalized cumulative histogram. Specifically, the frequency component correction control circuit 107 receives a gray scale conversion table memory output luminance level S107A output from the lookup table calculation circuit 105, and slope data S107B corresponding to this, and calculates a value which decreases with an increase in a value of the slope data S107B (specifically, for example, a frequency component correction gain S108B which is an inverse value of the slope data S107B). The frequency component correction gain S108B thus calculated is output in association with a frequency component correction table memory input luminance level S108A, which has the same value as that of the gray scale conversion table memory output luminance level S107A.

A frequency component correction table memory 108 stores the frequency component correction gain S108B and outputs a frequency component correction gain S109 which corresponds to the gray scale conversion luminance data S106. Specifically, for example, as illustrated in FIG. 3, the frequency component correction table memory 108 stores the frequency component correction gain S108B in a memory area which has, as an address, the frequency component correction table memory input luminance level S108A, and outputs the frequency component correction gain S109 which corresponds to the gray scale conversion luminance data S106 output from the gray scale conversion table memory 106.

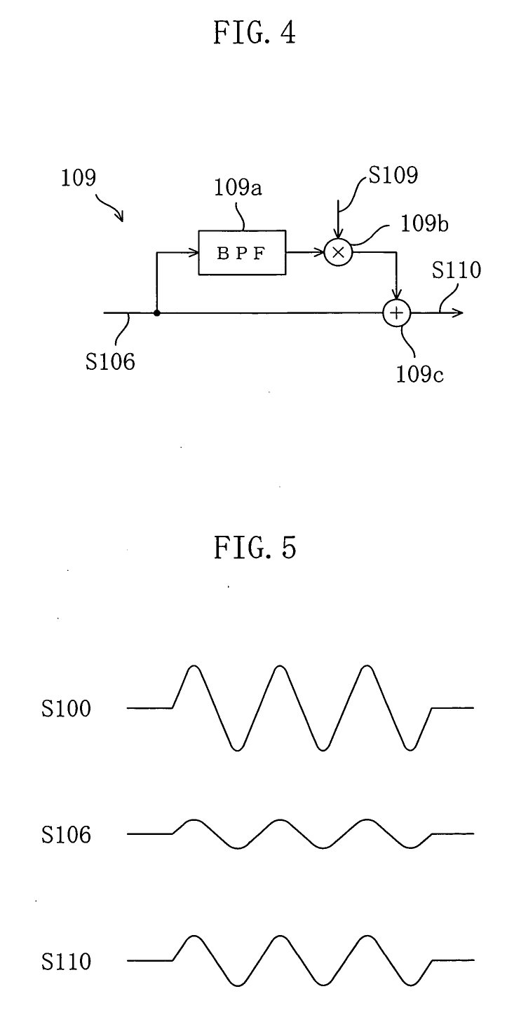

Specifically, for example, as illustrated in FIG. 4, the frequency component correction circuit 109 comprises a band-pass filter 109a (BPF) which passes a higher frequency component of the gray scale conversion luminance data S106, a multiplier 109b which multiplies an output of the band-pass filter 109a with the frequency component correction gain S109, and an adder 109c which adds a result of the multiplication to the gray scale conversion luminance data S106 and outputs frequency component-corrected luminance data S110. The frequency component correction circuit 109 increases frequency components (e.g., center frequency: 3.58 MHz; and upper limit frequency: 4.3 MHz), depending on the frequency component correction gain S109.

A DA converter 110 converts the frequency component-corrected luminance data S110, which has a digital value, into an analog signal, and outputs the analog signal as an output luminance signal S111.

A timing control circuit 111 controls operation timings of the circuits 102 to 106 of the gray scale conversion circuit 100.

Hereinafter, an operation of the video signal processing device thus configured will be described.

The input luminance signal S100 is converted into a digital signal by the AD converter 101, so that the input luminance value S101 is output for each pixel. The input luminance value S101 is provided as an address of the histogram memory 102, and is updated to a value obtained by increasing, by one, data stored at the address every time the input luminance value S101 is input. Note that the stored data is cleared (to 0) at predetermined time intervals (e.g., a one-vertical scanning time period, an integral multiple thereof, etc.).

Next, the histogram cumulative adder 103 reads the histogram data S102 held in the histogram memory 102 in sequence, cumulatively adds the histogram data S102, and stores the result (the cumulative histogram data S103) into the cumulative histogram memory 104.

Next, the lookup table calculation circuit 105 calculates a normalization coefficient which causes a maximum cumulative value of the cumulative histogram memory data S104 stored in the cumulative histogram memory 104 to be a maximum value of the output luminance level, multiplies the coefficient with each data value of the cumulative histogram memory 104, and stores the result (the normalized cumulative histogram data S105B) into the gray scale conversion table memory 106. Thereby, when the input luminance value S101 is input from the AD converter 101 to the gray scale conversion table memory 106, the gray scale conversion luminance data S106 which is obtained by gray scale conversion in accordance with the relationship of FIG. 2 is output.

The lookup table calculation circuit 105 outputs the gray scale conversion table memory output luminance level S107A, and calculates and outputs the slope data S107B corresponding to this. The frequency component correction control circuit 107 calculates the frequency component correction gain S108B which has a value which decreases with an increase in a value of the slope data S107B, and stores the frequency component correction gain S108B into the frequency component correction table memory 108. Specifically, as illustrated in FIG. 2 in combination, when the four slopes of the gray scale conversion table have a magnitude relationship, C<D<B<A, the frequency component correction gains S108B which have a magnitude relationship, a<b<d<c, are stored into the frequency component correction table memory 108. Thereby, when the gray scale conversion luminance data S106 is input from the gray scale conversion table memory 106 to the frequency component correction table memory 108, the frequency component correction gain S109 is output as illustrated in FIG. 3.

If the input luminance value S101 is input to the gray scale conversion table memory 106 when the gray scale conversion table memory 106 and the frequency component correction table memory 108 have been set as described above, the input luminance value S101 is subjected to gray scale conversion and the resultant gray scale conversion luminance data S106 is output. Specifically, a larger number of gray scales are assigned to a higher frequency of luminance, so that a luminance distribution is flattened. For example, when a cumulative histogram is normalized as described above, a gray scale of a maximum luminance is also assigned, thereby expanding a dynamic range.

Thereafter, the frequency component correction gain S109 corresponding to the gray scale conversion luminance data S106 is output from the frequency component correction table memory 108, and is subjected to a process of increasing a predetermined frequency component of the gray scale conversion luminance data S106 by an amount corresponding to the frequency component correction gain S109 by the frequency component correction circuit 109, so that the frequency component-corrected luminance data S110 is output. Specifically, for example, as illustrated in FIG. 5, if a luminance level of the input luminance signal S100 accounts for a small proportion of the whole screen, the number of gray scales (amplitude level, dynamic range) is reduced for the gray scale conversion luminance data S106 output from the gray scale conversion table memory 106. However, the amplitude level of a higher frequency component included in that portion is increased by the frequency component correction circuit 109, and the result is output as the frequency component-corrected luminance data S110. Therefore, the reduction of the contrast of a portion including a fine picture pattern or the like is suppressed or prevented from being reduced due to gray scale conversion, thereby making it possible to obtain a high-contrast output signal.

Although, in the above-described example, the frequency component correction control circuit 107 calculates the inverse of the slope data S107B as the frequency component correction gain S108B, the present invention is not limited to this. Alternatively, a value obtained by subtracting the slope data S107B from a predetermined value may be calculated, or a function or a table which can obtain a value corresponding to the slope data S107B may be used. Alternatively, a gain adjustment circuit which adds a value set in a predetermined register to the inverse of the slope data S107B may be provided, and the above-described correction may be performed by controlling the value of the register, so that the frequency component correction gain S108B can be more uniformly adjusted.

In the above-described example, the frequency component correction gain S108B is set to vary in a stepwise manner. Alternatively, for example, a sudden change in the frequency component correction gain may be suppressed to stabilize the change by using values obtained by subjecting the frequency component correction gain S108B and the slope data S107B to a low-pass filter process, so that unnaturalness is suppressed at a change point of the frequency component correction gain.

Also in the above-described example, the band-pass filter 109a which passes a higher frequency component is used, the output of the band-pass filter 109a is added to the original data (the above-described frequency component is amplified). The present invention is not limited to this. Alternatively, a band-elimination filter may be used, an output of the filter may be subjected to subtraction (the frequency component is attenuated), or these may be selectable, and further, the frequency characteristics of the filter may be adjustable, so that a video signal process having characteristics corresponding to various video contents or the like is performed. More specifically, for example, sharpness can be increased by, for example, increasing a higher frequency component when the number of gray scales is reduced as described above, and the influence of noise can be reduced by decreasing a higher frequency component when the number of gray scales is increased.

In the above-described example, the frequency component correction gain S109 is calculated based on the gray scale conversion luminance data S106. Alternatively, the frequency component correction gain S109 may be calculated based on the input luminance value S101, for example. In other words, if a lookup table is created depending on a parameter used, the same correction can be performed.

In the above-described example, gray scale conversion and frequency component correction are performed using hardware. Alternatively, these processes may be similarly performed using a processor (a signal processing processor (DSP), etc.) and software, or such a configuration may be combined with hardware.

### Embodiment 2

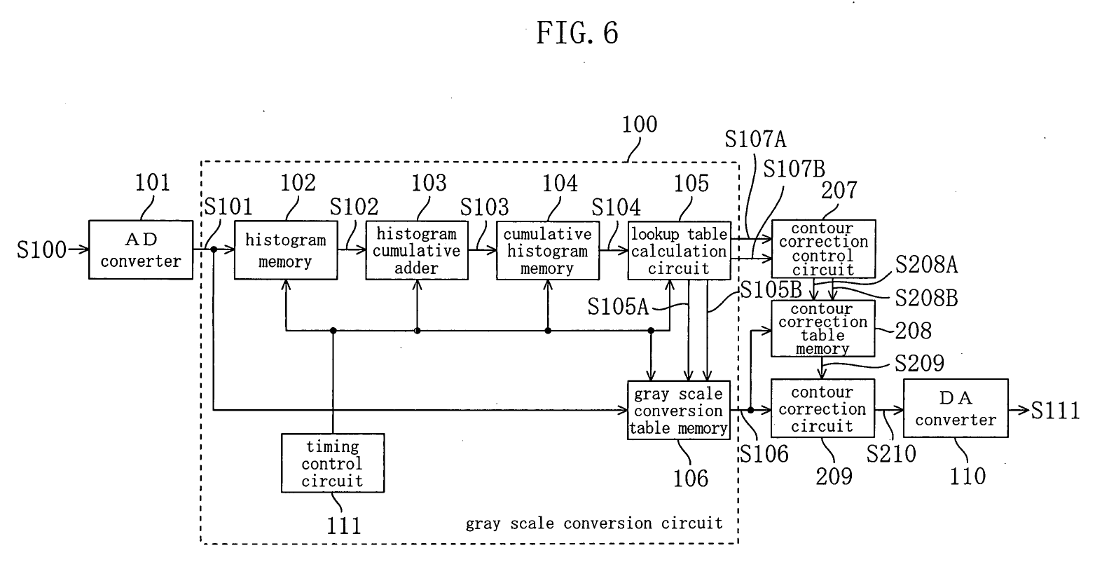

Instead of the above-described frequency component correction (or in combination with this), contour emphasis may be performed. Specifically, a video signal processing device of Embodiment 2 is different from that of the device of Embodiment 1 in that, for example, as illustrated in FIG. 6, the video signal processing device of Embodiment 2 comprises a contour correction control circuit 207, a contour correction table memory 208, and a contour correction circuit 209 instead of the frequency component correction control circuit 107, the frequency component correction table memory 108, and the frequency component correction circuit 109.

The contour correction control circuit 207 and the contour correction table memory 208 are similar to the frequency component correction control circuit 107 and the frequency component correction table memory 108 of Embodiment 1, however, a contour correction table memory input luminance level S208A, a contour correction gain S208B, and a contour correction gain S209 which are output therefrom take values, depending on the control of the degree of contour correction (note that, if values used are the same, the same value is actually used).

The contour correction circuit 209 performs a contour emphasis process of emphasizing a contour of video by a degree corresponding to the contour correction gain S209 with respect to the gray scale conversion luminance data S106 output from the gray scale conversion table memory 106. The contour emphasis process method is not particularly limited, and includes, for example, a method calculating a first-order differential and a second-order differential of a video signal and adding a shoot component (rimming) to an edge portion to provide a high contrast, a method of causing the transient of a signal to be steep so that a so-called “sharpness” of a contour portion is improved, and the like.

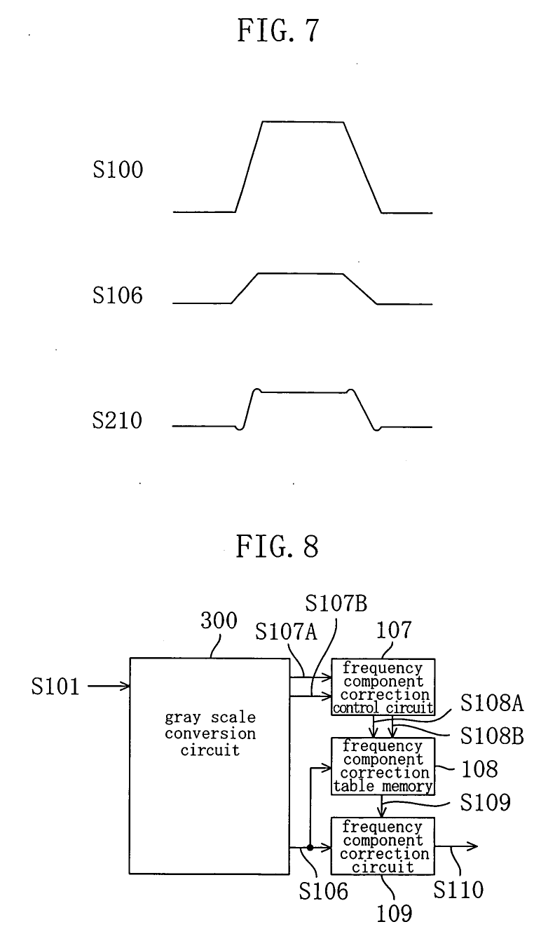

Specifically, for example, as illustrated in FIG. 7, when the amplitude of the gray scale conversion luminance data S106 is suppressed to a small value with respect to the input luminance signal S100 by gray scale conversion performed by the gray scale conversion table memory 106, contour correction luminance data S210 is output in which a change amount of luminance is increased in the vicinity of an edge portion (where the luminance suddenly changes) by overshoot or undershoot. Therefore, even when gray scale correction which reduces the number of gray scales is performed, a reduction in sharpness of that portion is suppressed or prevented.

### Embodiment 3

As described above, frequency component correction and contour correction are performed in combination with gray scale conversion which is performed based on a luminance histogram. The present invention is not limited to this. Frequency component correction and contour correction may be performed in combination with gray scale conversion including gray scale compression or expansion. In this case, a contrast and a sharpness can be similarly maintained high, for example.

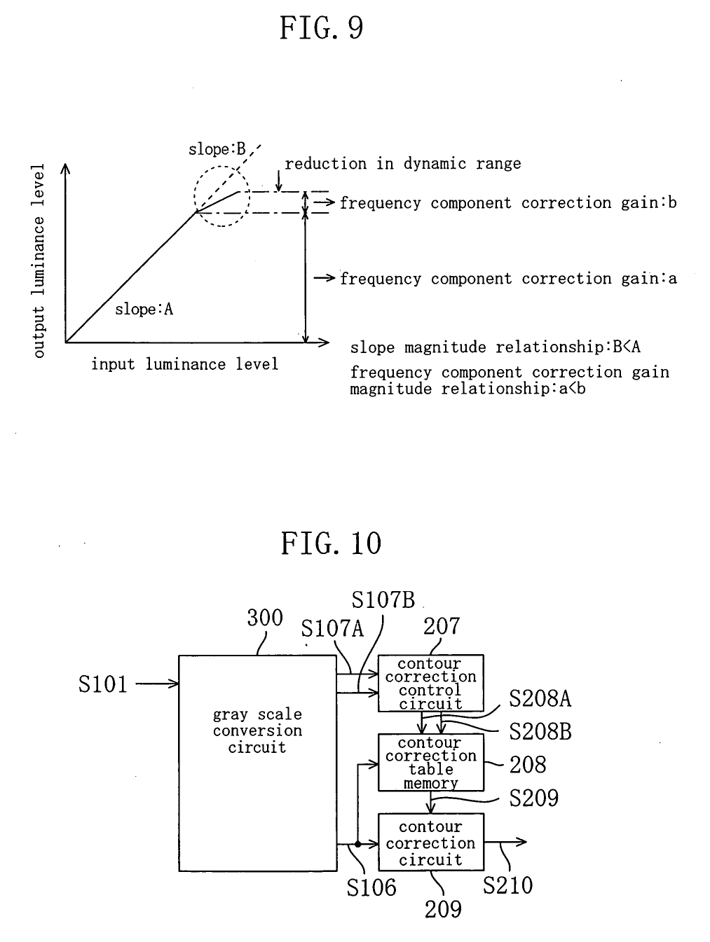

Specifically, for example, as illustrated in FIG. 8, a gray scale conversion circuit 300 which has conversion characteristics as illustrated in FIG. 9 may be combined with the frequency component correction circuit 109 or the like. Alternatively, the gray scale conversion circuit 300 may be combined with the contour correction circuit 209 as illustrated in FIG. 10. Specifically, for example, the gray scale conversion circuit 300 subjects an input luminance level which is smaller than or equal to a predetermined threshold to a conversion which is represented by a straight line having a ratio of 1:1 (FIG. 9), i.e., the luminance level is not actually changed, and an input luminance level which is larger than or equal to the predetermined threshold to gray scale compression. For example, such a process may be performed so as to reduce a dynamic range in, for example, a digital camera or the like.

Also in the above-described gray scale conversion, by subjecting an input signal which is larger than or equal to the above-described threshold and whose gray scale is compressed, to a correction (e.g., an increase in a higher component, contour emphasis, etc.) as described above, a contrast and a sharpness can be easily improved.

Note that, for example, when the characteristics of gray scale conversion are previously determined as described above, the frequency component correction table memory 108, the contour correction table memory 208, and the like may be similarly previously set, so that the frequency component correction control circuit 107 and the contour correction control circuit 207 may not be provided.

The variations and the like described in Embodiment 1 may be combined in various manners within a possible range and may be applied to Embodiments 2 and 3. Specifically, for example, in Embodiment 3, when an input luminance level is in the vicinity of a threshold, a value processed by a low-pass filter, or the like, may be used as a value which is held in the frequency component correction table memory 108 so that the degree of frequency component correction or contour correction does not vary significantly.

As described above, according to the present invention, for example, a reduction in sharpness is suppressed in a luminance portion which is assigned with a less number of gray scales by luminance conversion (e.g., a luminance portion having a small cumulative frequency in a luminance distribution, etc.), thereby making it possible to improve image quality.

What is claimed is:

1. A video signal processing device, comprising:
a gray scale conversion section of receiving first luminance signal data, and based on the first luminance signal data, subjecting the luminance signal data to gray scale conversion into second luminance signal data; and
a correction section of subjecting the second luminance signal data to at least one of frequency component correction which increases or decreases a predetermined frequency component, and contour emphasis correction which emphasizes a contour portion, based on at least one of the first luminance signal data and the second luminance signal data.

2. The video signal processing device of claim 1, wherein the correction section is configured so that a ratio of a difference between two post-conversion values obtained when two pre-conversion values having a predetermined difference, a range between the two pre-conversion values including a certain value of the first luminance signal data, are subjected to gray scale conversion in the gray scale conversion section, to a difference between the two pre-conversion values, is smaller than a ratio corresponding to another value of the first luminance signal data, the frequency component correction which further increases the predetermined frequency component or the contour emphasis correction which further emphasizes a contour portion, is performed.

3. The video signal processing device of claim 1, wherein the gray scale conversion section is configured so that the conversion into the second luminance signal data is performed based on a luminance histogram indicating a luminance distribution of the first luminance signal data.

4. The video signal processing device of claim 3, wherein the gray scale conversion section is configured to perform the gray scale conversion so that a value of the second luminance signal data corresponding to each first luminance signal data becomes equal to a value which is in proportion to a cumulative value of a frequency corresponding to a luminance of luminance signal data in the luminance histogram.

5. The video signal processing device of claim 4, wherein the correction section is configured to perform the frequency component correction which increases the predetermined frequency component or the contour emphasis correction with respect to a luminance of a portion which has a small slope of a cumulative value of a frequency corresponding to a luminance in the luminance histogram rather than a portion which has a large slope thereof.

6. The video signal processing device of claim 5, wherein the correction section is configured to perform the frequency component correction or the contour emphasis correction, depending on an inverse of the slope.

7. The video signal processing device of claim 6, wherein the correction section is configured to perform the frequency component correction or the contour emphasis correction, depending on a value obtained by adding an adjustable predetermined value to the inverse of the slope.

8. The video signal processing device according to claim 5, wherein the correction section is configured to perform the frequency component correction or the contour emphasis correction, depending on the slope having a predetermined number of stages corresponding to the predetermined number of ranges into which the luminance in the luminance histogram is divided.

9. The video signal processing device of claim 8, wherein the correction section is configured to perform the frequency component correction or the contour emphasis correction, depending on a value obtained by subjecting a value of the slope having the predetermined number of stages or an inverse thereof to a low-pass filter process.

10. The video signal processing device of claim 1, wherein the gray scale conversion section is configured to perform gray scale conversion which reduces a luminance range with respect to a luminance in the first luminance signal data which is larger than or equal to a predetermined reference luminance, and
the correction section is configured to perform the frequency component correction or the contour emphasis correction with respect to the second luminance signal data corresponding to the first luminance signal data which is larger than or equal to the predetermined reference luminance.

11. A video signal processing method, comprising the steps of:
receiving first luminance signal data, and based on the first luminance signal data, subjecting the luminance signal data to gray scale conversion into second luminance signal data; and
subjecting the second luminance signal data to at least one of frequency component correction which increases or decreases a predetermined frequency component, and contour emphasis correction which emphasizes a contour portion, based on at least one of the first luminance signal data and the second luminance signal data.
